(19) United States
(12) Patent Application Publication
(10) Pub. No.: US 2023/0222237 A1
(43) Pub. Date: Jul. 13, 2023

(54) VIRTUAL COMPUTING INSTANCE AGENT AUTHENTICATION IN A PUBLIC CLOUD

(71) Applicant: VMware, Inc., Palo Alto, CA (US)

(72) Inventors: Mandar Nanivadekar, Pune (IN); Leena Shuklendu Soman, Pune (IN)

(21) Appl. No.: 17/690,022

(22) Filed: Mar. 9, 2022

(30) Foreign Application Priority Data
Jan. 13, 2022 (IN) 202241001996

(51) Int. Cl. G06F 21/62; G06F 21/60

(52) U.S. Cl. CPC G06F 21/6218; G06F 21/602; G06F 2221/2141

(57) ABSTRACT

Virtual computing instance (VCI) agent authentication in a public cloud can include running a periodic task by an agent on a VCI created from a VCI base image on a public cloud backend, where the VCI base image includes the agent. The periodic task can include querying a basic input/output system (BIOS) identifier of the VCI and calculating a hash of a string of media access control (MAC) addresses associated with the VCI. In response to the BIOS identifier and/or the hash not being stored in association with the agent, the periodic task can include authenticating the agent with the public cloud backend.

### RELATED APPLICATION

Benefit is claimed under 35 U.S.C. 119(a)-(d) to Foreign Application Serial No. 202241001996 filed in India entitled “VIRTUAL COMPUTING INSTANCE AGENT AUTHENTICATION IN A PUBLIC CLOUD”, on Jan. 13, 2022, by VMware, Inc., which is herein incorporated in its entirety by reference for all purposes.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a system for virtual computing instance agent authentication in a public cloud according to one or more embodiments of the present disclosure.

FIG. 2 is a flow chart for virtual computing instance agent authentication in a public cloud according to one or more embodiments of the present disclosure.

FIG. 3 is a flow chart for virtual computing instance agent authentication in a public cloud according to one or more embodiments of the present disclosure.

FIG. 4 is a flow chart for virtual computing instance agent authentication in a public cloud according to one or more embodiments of the present disclosure.

FIG. 5 is a flow chart for virtual computing instance agent authentication in a public cloud according to one or more embodiments of the present disclosure.

### DETAILED DESCRIPTION

The term “virtual computing instance” (VCI) covers a range of computing functionality , such as virtual machines, virtual workloads, data compute nodes, clusters, and containers, among others. A virtual machine refers generally to an isolated user space instance, which can be executed within a virtualized environment. Other technologies aside from hardware virtualization can provide isolated user space instances, also referred to as data compute nodes, such as containers that run on top of a host operating system without a hypervisor or separate operating system and/or hypervisor kernel network interface modules, among others. Hypervisor kernel network interface modules are data compute nodes that include a network stack with a hypervisor kernel network interface and receive/transmit threads. The term “VCI” covers these examples and combinations of different types of data compute nodes, among others.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs. While the present disclosure refers to VCIs, the examples given could be any type of virtual object, including data compute node, including physical hosts, VCIs, non-VCI containers, virtual disks, and hypervisor kernel network interface modules. Embodiments of the present disclosure can include combinations of different types of data compute nodes.

One way to create a VCI in a public cloud environment is to spawn it on-demand from an already created VCI base image or from another VCI. The term public cloud refers to computing services offered publicly over the Internet. A public cloud frond end refers to the user-facing part of the cloud computing architecture, such as software, user interface, and client-side devices. A public cloud backend refers to components of the cloud computing system, such as hardware, storage, management, etc., that allow the front end to function as desired. Some public cloud backends allow customers to rent VCIs on which to run their applications. Users can boot a VCI base image to configure VCIs therefrom. Users can create, launch, and terminate such VCIs as needed. Users can be charged, for example, for the time during which the VCI is in operation. In some approaches, the VCI base image is a virtual appliance comprising a read-only file system image with an operating system.

In some instances, an agent can be installed on the VCI base image and replicated to any VCI created therefrom. The term agent refers to software designed to perform one or more functions for another party or another program. For example, an agent can be installed on a VCI in order to enable it to communicate with and/or act on behalf of systems external to the VCI and/or the infrastructure on which the VCI is running. One example of functionality provided by such an agent is security (e.g., the agent can be an antivirus sensor). A security agent can provide cloud native endpoint security, detect malicious behavior and prevent malicious files from attacking an organization, use predictive security cloud analytics to analyze customer data, etc. Customers may expect that agents installed on a VCI base image will be replicated seamlessly to VCIs spawned therefrom at the time of creation. However, some agents (e.g., proprietary agents) installed on VCIs running in a public cloud backend may not behave according to such expectations. For example, an agent may be expected to authenticate and/or register with the public cloud backend. That process may or may not involve the generation of a unique agent identifier for further communication with the public cloud backend. The agent may use the agent identifier to communicate events and alerts after authentication in order to differentiate such traffic from other agents. However, for some agents that are not controlled by the public cloud backend, there may not be an automated process for a new instance of the agent to authenticate with the public cloud backend. For example, when a new VCI is created from the VCI base image (or another VCI), the agent on the new VCI may inherit the agent identifier of the agent on the VCI from which the new VCI was created, or some systems may not use agent identifiers.

At least one embodiment of the present disclosure addresses these and other drawbacks of some previous approaches. For example, various characteristics of the agent and/or the VCI on which the agent is installed can be checked as a means of identifying and distinguishing the agent from other agents to determine whether an agent should be authenticated with the public cloud backend. Examples of such characteristics include a basic input/output system (BIOS) identifier, which is unique to each VCI, and media access control (MAC) addresses associated with the VCI.

The VCI and/or the public cloud backend can maintain a database that can be checked by agents installed on the VCIs to facilitate a determination of whether the agent should be authenticated with the public cloud backend. In some embodiments, a respective database be maintained by each VCI. In some embodiments, a common database can be maintained on the public cloud backend. In some embodiments, a hybrid database can be maintained by the VCIs and the public cloud backend. As used herein, the phrase “database associated with the VCI” refers to a database that stores data associated with the VCI whether the database is maintained by the VCI, the public cloud backend, or both. The database can be queried for a particular characteristic (e.g., for a particular BIOS identifier). A negative result for the query can indicate either an absence of the queried characteristic or a mismatch of the characteristic (e.g., a different BIOS identifier being stored in place of the queried BIOS identifier) in the database. The present disclosure refers to various actions that can be taken in response to such a negative result without distinguishing between absence and mismatch. For example, the phrase “determine whether a current BIOS identifier of the VCI matches a BIOS identifier stored in the database” can have a negative result based on either absence of the BIOS identifier from the database or a mismatch for the queried BIOS identifier.

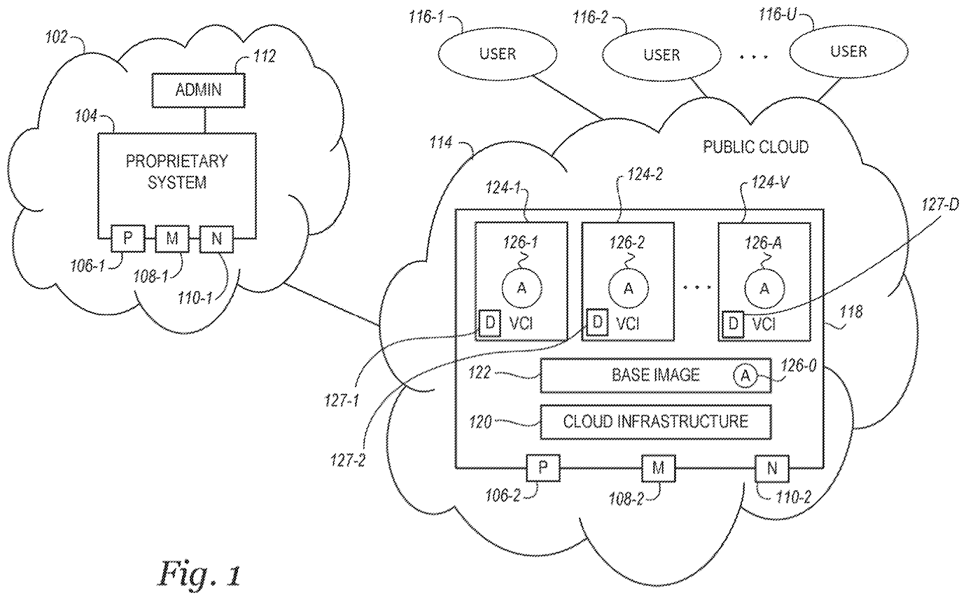

The figures herein follow a numbering convention in which the first digit or digits correspond to the drawing figure number and the remaining digits identify an element or component in the drawing. Similar elements or components between different figures may be identified by the use of similar digits. Analogous elements within a Figure may be referenced with a hyphen and extra numeral or letter. See, for example, elements 124-1, 124-2, 124-V in FIG. 1. Such analogous elements may be generally referenced without the hyphen and extra numeral or letter. For example, elements 124-1, 124-2, 124-V may be collectively referenced as 124. As used herein, the designators “A”, “U”, and “V”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present disclosure, and should not be taken in a limiting sense.

FIG. 1 is a diagram of a system for virtual computing instance agent authentication in a public cloud 114 according to one or more embodiments of the present disclosure. The system can include a private, proprietary, or hybrid cloud 102 connected to the public cloud 114. The cloud 102 can include a proprietary system 104 that includes processing resources 106-1 (e.g., a number of processors), memory resources 108-1, and/or a network interface 110-1. The public cloud serves a number of users 116-1, 116-2, . . . , 116-U. As used herein, the term proprietary (e.g., vendor-specific, third-party, or non-public) is used in contrast to public (e.g., open source, first-party, or available to public users 116). Examples of the proprietary system 104 include a single computer, a distributed computing system, a host providing virtualization, and a data center, among others. The proprietary system 104 can connect to the VCIs 124, configure the base image 122, or perform other operations on the public cloud 114 as described herein. The proprietary system 104 can be in communication with an administrator 112. In some embodiments, the administrator 112 can be a computer or web client accessed or operated by a human administrator.

The public cloud 114 can include a public cloud backend 118. The public cloud backend 118 can include processing resources 106-2, memory resources 108-2, and/or network interfaces 110-2. In some embodiments, the public cloud backend 114 can represent one or more hosts included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The public cloud backend 118 can include a cloud infrastructure 120, such as a hypervisor, that can execute a VCI base image 122 and/or a number of VCIs 124-1, 124-2, . . . , 124-V. The VCI base image 122 and/or VCIs 124 can be provisioned with the processing resources 106-2 and memory resources 108-2 and can communicate via the network interfaces 110-2. The processing resources 106-2 and the memory resources 108-2 provisioned to the VCI base image 122 and/or VCIs 124 can be local and/or remote to the public cloud backend 118. For example, in a software defined data center, the VCI base image 122 and/or VCIs 124 can be provisioned with resources that are generally available to the software defined data center and not tied to any particular hardware device.

The VCI base image 122 can be created for the purpose of creating additional VCIs 124 based thereon. The VCI base image 122 can provide the information used to launch VCIs 124 copied therefrom. Multiple VCIs 124 can be launched from a single VCI base image 122. The VCI base image 122 can include snapshots for storage associated with the VCI base image 122, permissions associated with the VCI base image 122, etc. The VCI base image 122 may be referred to as a template. The additional VCIs 124 may be referred to as clones and generally inherit properties of the VCI base image (e.g., permissions, agents 126, etc.). The VCI base image 122 can have a guest operating system installed thereon. The VCI base image 122 can have an agent 126-0 installed thereon. The agent 126-0 can enable communication between the VCI base image 122 and the proprietary system 104. The agent 126-0 can perform functions using the VCI base image 122 on behalf of the proprietary system 104. When a VCI 124 is created from the VCI base image 122, the agent 126-0 is also copied to the VCI 124 (e.g., VCI 124-1 includes the agent 126-1, VCI 124-2 includes the agent 126-2, VCI 124-V includes the agent 126-A). The agents 126 on the VCIs 124 provide analogous functionality thereto as the agent 126-0 does for the VCI base image 122.

An example of an agent 126 is a network security sensor. Users 116 of the public cloud 114 may wish to use proprietary (e.g., third-party) security services provided by the proprietary system 104. Such users 116 may elect to install the agent 126 on their VCIs 124 and can therefore install the agent 126-0 on the VCI base image 122, expecting that each VCI 124 created therefrom will be protected by its respective agent 126. When the agent 126-0 is installed on the VCI base image 122, the agent 126-0 can authenticate and/or register with the public cloud backend 118. As part of the authentication and/or registration process, some public cloud backends 118 issue an agent identifier to the agent 126-0 on the VCI base image 122 (however, some may not). The agent identifier can be used to facilitate communication between the agent 126-0 and the public cloud backend 118. When a VCI 124-1 is created from the VCI base image 122, the agent 124-1 on the VCI 124-1 may inherit the agent identifier assigned to the agent 126-0 on the VCI base image 122 or not receive an identifier at all. Using a duplicated agent identifier (or not using an identifier) can prevent proper logging, characterization, or other network security functions for communications associated with different agents 126. The agent 126-1 of the new VCI 124-1 should be authenticated and/or registered with the public cloud backend 118 in order to facilitate communication between the agent 126-1 and the public cloud backend 118, however, according to some previous approaches, there is not an automated way of forcing such authentication and/or registration.

At least one embodiment of the present disclosure provides for automatic determination whether agents 126 installed on VCIs 124 have been or need to be authenticated and/or registered with the public cloud backend 118. Some embodiments of the present disclosure can use various characteristics, such as any or all of a BIOS identifier of the VCI 124, a hash of MAC addresses associated with the VCI 124, and an instance identifier of the VCI 124 (“VCI identifier”) to facilitate this determination. The VCI identifier is assigned by some, but not all, public cloud backends to distinguish between different VCIs 124. Any one of these characteristics alone may not be sufficient to determine that the agent 126 is properly authenticated and/or registered with the public cloud backend 118. For example, some public cloud backends 118 use identical BIOS identifiers for all VCIs 124. In some instances, MAC addresses may be reused or altered, such as when VCIs are shut down or when network interface cards (NICs) are added or removed. VCI identifiers are not used by all public cloud backends 118. Various embodiments of the present disclosure advantageously make use of multiple characteristics to determine whether agents 126 are properly authenticated and/or registered.

The agents 126 can be configured to query characteristics, such as a BIOS identifier of the VCI 124 on which they are installed, MAC addresses associated with the VCI 124 on which they are installed, and/or their own VCI identifier (e.g., from a link local Internet protocol connection). The agents 126 can be configured to sort the MAC addresses and create a hash (e.g., a secure hash algorithm, such as SHA-256) of the sorted MAC addresses. Sorting the MAC addresses before hashing can help prevent undesired reauthentication of agents 126 as described in more detail herein. The agents 126 can be configured to cause any or all of the characteristics to be stored in a database on the public cloud backend 118 (e.g., in memory resources 108-2) and/or in respective databases 127-1, 127-2,. . . , 127-D associated with each VCI 124 for later comparison.

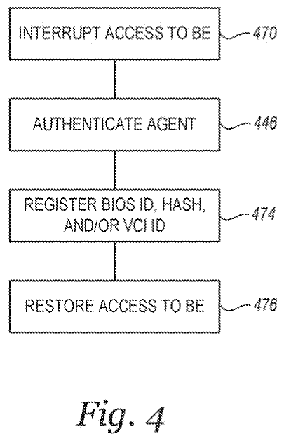

The authentication and/or registration process may generally be referred to herein as authentication for simplicity. Some differences between authentication and registration are described with respect to FIG. 4. The specific manner in which an agent is authenticated will be understood by one of ordinary skill in the art, however embodiments are not limited to any particular authentication process.

The public cloud backend 114 can be configured to (e.g., execute instructions to) create the VCI base image 122 and install the agent 126-0 on the VCI base image 122. The agent 126-0 can be proprietary software, which can be executed by the VCI base image 122. The agent 126-0 can be configured to query a BIOS identifier of the VCI base image 122 and store it in a database. The agent 126-0 can be configured to query MAC addresses associated with the VCI base image 122, calculate a hash of the MAC addresses, and store the hash in the database. The agent 126-0 can be configured to create a periodic task. The periodic task can be executed by the agent 126-0 or any other agent 126-1, 126-2, . . . , 126-A replicated therefrom. The periodic task can include instructions to query a BIOS identifier and MAC addresses associated with the VCI 124 on which the agent 126 is installed, calculate a hash of the MAC addresses, and authenticate the agent 126 with the public cloud backend 114 on which the VCI 124 and/or the VCI base image 122 are running in response to either the BIOS identifier or the hash not being found in the database.

The public cloud backend 114 can be configured to create the VCIs 124-1, 124-2, . . . , 124-V from the VCI base image 122. Each VCI 124 can include a respective agent 126-1, 126-2, . . . , 126-A replicated from the agent 126-0 installed on the VCI base image 122. For embodiments in which the database is operated by the public cloud backed 114, the public cloud backend 114 can be configured to provide the respective agents 126 with access to the database. The agent 126-0 can be configured to cause a BIOS identifier associated with the VCI base image 122 and/or a hash of MAC addresses associated with the VCI base image to be stored in the database.

A respective agent 126 can be configured to periodically query the current BIOS identifier of the VCI on which it is installed, query the MAC addresses associated with the VCI, and calculate the current hash of MAC addresses. The respective agent 126 can be configured to sort the MAC addresses before calculating the hash, and to sort them in a same order each time the hash is calculated. The respective agent 126 can be configured to periodically determine whether a current BIOS identifier of the VCI 124 on which it is installed matches a BIOS identifier stored in the database. The respective agent 126 can be configured to periodically determine whether a current hash of MAC addresses associated with the VCI on which it is installed matches a hash stored in the database. In response to not finding a match for either the current BIOS identifier or the current hash in the database, the respective agent 126 can interrupt access to the public cloud backend until authenticated. The respective agent 126 can be configured to authenticate with the public cloud backend 114 in response to not finding a match for either the current BIOS identifier or the current hash. The respective agent 126 can be configured to cause a BIOS identifier associated with the VCI 124 on which it is installed and/or a hash of MAC addresses associated with the VCI 124 to be stored in the database (e.g., in response to not finding a match the respective characteristic therein and/or as part of the authentication process). The respective agent 126 can be configured to periodically query a VCI identifier of the VCI 124 on which the agent is installed and periodically determine whether the VCI identifier matches a corresponding VCI identifier stored in the database. The respective agent 126 can be configured to interrupt access to the public cloud backend 114 until authenticated in response to not finding a match for the VCI identifier in the database.

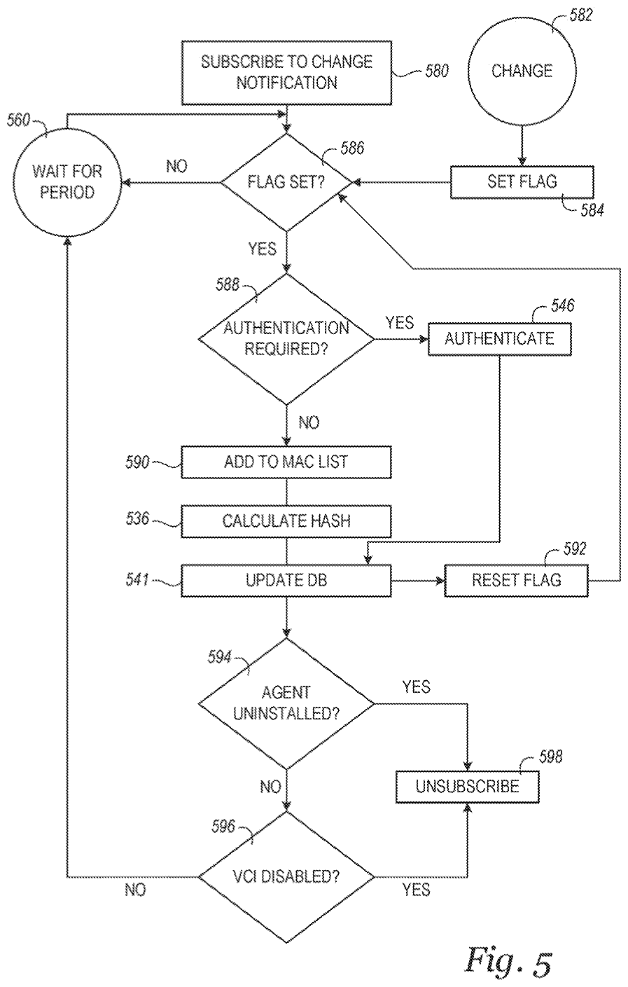

A change notification system can be configured to notify the respective agent 126 in response to a change in any MAC address associated with the VCI 124 on which the respective agent 126 is installed. The change notification system is described in more detail with respect to FIG. 5. When the agent 126 is initialized for the first time, it can create a change notification system to run on the VCI 124 on which it is installed. The guest operating system on the VCI 124 can notify the agent 126 in response to a change in any MAC address associated with the VCI 124 per the change notification system. The respective agent 126 can be configured, in response to being notified of the change, to recalculate the current hash and to cause the hash stored in the database to be updated.

The processing resources 106 can be coupled to the memory resources 108 via a communication path. The communication path can be local or remote to the device using the processing resources 106 and/or the memory resources 108. Examples of a local communication path can include an electronic bus internal to a machine, where the memory resources 108 are in communication with the processing resources 106 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path can be such that the memory resources 108 are remote from the processing resources 106, such as in a network connection between the memory resources 108 and the processing resources 106. That is, the communication path can be a network connection. Examples of such a network connection can include a local area network (LAN), wide area network (WAN), personal area network (PAN), and the Internet, among others.

Memory resources 108, such as a machine-readable medium (MRM), can be internal and/or external to the device using them. Memory resources can store program instructions. Program instructions may also be referred to as software or machine-readable instructions (MRI) to implement a particular function (e.g., an action such as authenticating a VCI agent in a public cloud, as described herein). The memory resources 108 can be coupled to the device using them in a wired and/or wireless manner. For example, the memory resources 108 can be an internal memory, a portable memory, a portable disk, and/or a memory associated with another resource (e.g., enabling MRI to be transferred and/or executed across a network such as the Internet). The MRI can be executable by processing resources 106.

Memory resources 108 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

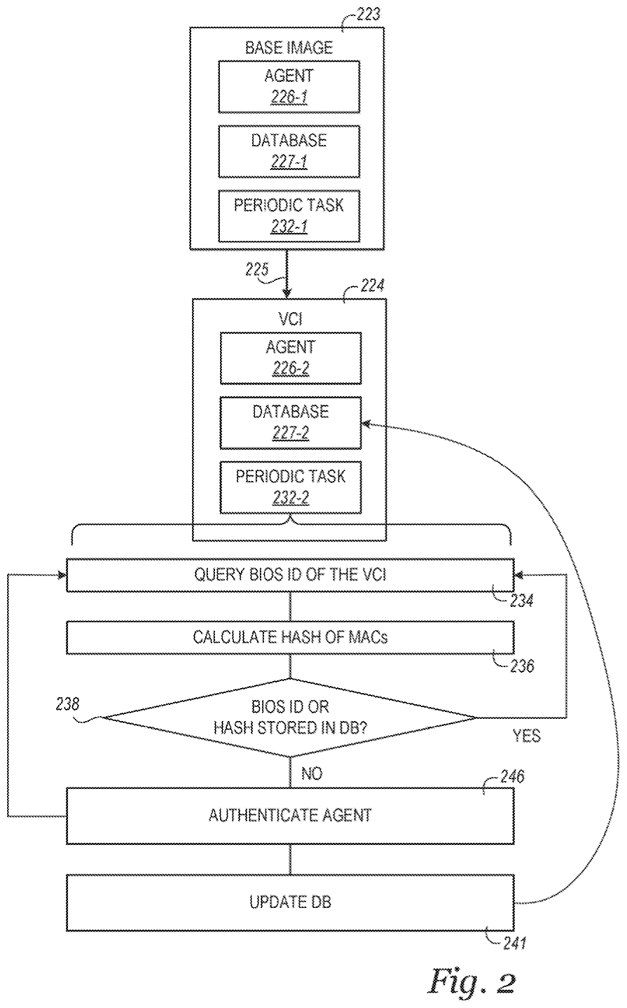

FIG. 2 is a flow chart for virtual computing instance agent authentication in a public cloud according to one or more embodiments of the present disclosure. The flow chart can represent a method that can be performed by processing logic that can include hardware (e.g., a processing device, circuitry, dedicated logic, programmable logic, microcode, hardware of a device, integrated circuit, etc.), software (e.g., instructions run or executed on a processing device), or a combination thereof. For example, the method can be performed by a server and/or a VCI (e.g., a VCI 124, previously described in connection with FIG. 1), though embodiments of the present disclosure are not so limited. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

A VCI base image 223 is illustrated as having an agent 226-1 and a database 227-1 installed thereon. The VCI base image 223 can also include instructions executable to perform a periodic task 232-1 installed thereon. A VCI 224 can be created from the VCI base image 223 as indicated by the arrow 225. The VCI 224 can have a replica 226-2 of the agent 226-1, a replica 227-2 of the database 227-1, and a replica 232-2 of the periodic task 232-1 installed thereon. When the VCI 224 is initially created, the database 227-2 is likely to be inaccurate for the VCI 224 because it will be populated with data corresponding to the VCI base image 223.

Additional details of the periodic task 232-2 are illustrated below the VCI 224. The periodic task 232-2 can run on the VCI 224 created from the VCI base image 223 on a public cloud backend. The periodic task 232-1 can be created by the agent 226-1 installed on the VCI base image 223 and copied to the VCI 224 (and any other VCIs) created therefrom. The periodic task 232-2 can be run by the VCI 224 on which the agent 226-2 is installed at a configurable interval (period), such as every minute. The task can run periodically (e.g., after being configured to do so), in order to automatically cause the detection of unauthenticated agents. If, for example, the task ran once, caused authentication of the agent 226-2, and stopped, then the agents installed on subsequently created VCIs would not be detected as needing authentication because the new agent would essentially inherit the state of the agent from which it is created (thus having a state indicating that the task had already been completed).

The periodic task 232-2 can include a number of elements, not limited to those illustrated in FIG. 2. However, in at least one embodiment, the periodic task 232-2 includes, querying a BIOS identifier of the VCI on which the agent is installed (as illustrated at 234), calculating a hash of a string of MAC addresses associated with the VCI (as illustrated at 236), and, in response to the BIOS identifier or the hash not being stored in a database (as illustrated by the “no” path from 238), authenticating the agent with the public cloud backend (as illustrated at 246). Although not specifically illustrated, in at least one embodiment the periodic task 232-2 includes querying the MAC addresses associated with the VCI and sorting them into a list before calculating the hash of the MAC addresses. In some embodiments, if both the BIOS identifier and the hash are stored in the database, the periodic task 232-2 can run again (at the next period) as indicated by the “yes” path from 238. In some embodiments, if either of the BIOS identifier and the hash are stored in the database, the periodic task 232-2 can run again (at the next period) as indicated by the “yes” path from 238.

In some embodiments, the method can also include querying a VCI identifier of the VCI on which the agent is installed and, in response to the VCI identifier not being stored in the database, authenticating the agent with the public cloud backend. The VCI identifier is an additional characteristic that can be used to determine whether the agent 226-2 has already been authenticated as part of the periodic task 232-2.

The method can include causing the BIOS identifier and/or the hash to be stored in the database (e.g., after or as part of the authentication) as indicated at 241. The method can include the agent receiving an updated MAC address from a change notification system, calculating a new hash of the string of MAC addresses associated with the VCI (the string having the updated MAC substituted therein for the MAC that it replaced), and causing the new hash to be stored the database without reauthenticating the agent. The change notification system can be useful for instances in which a MAC address associated with the VCI is changed without triggering an undesired reauthentication of the agent installed on the VCI. A MAC address could change due to a change in properties of a VCI, if an additional NIC is added to the VCI, a change in the hypervisor, etc.

Although not specifically illustrated, the method can include storing a BIOS identifier of the VCI base image 223 in the database 227-1, calculating a hash of a string of MAC addresses of the VCI base image 223, and storing that hash in the database 227-1. The method can include creating the periodic task 232-1 to run on the VCI base image 223.

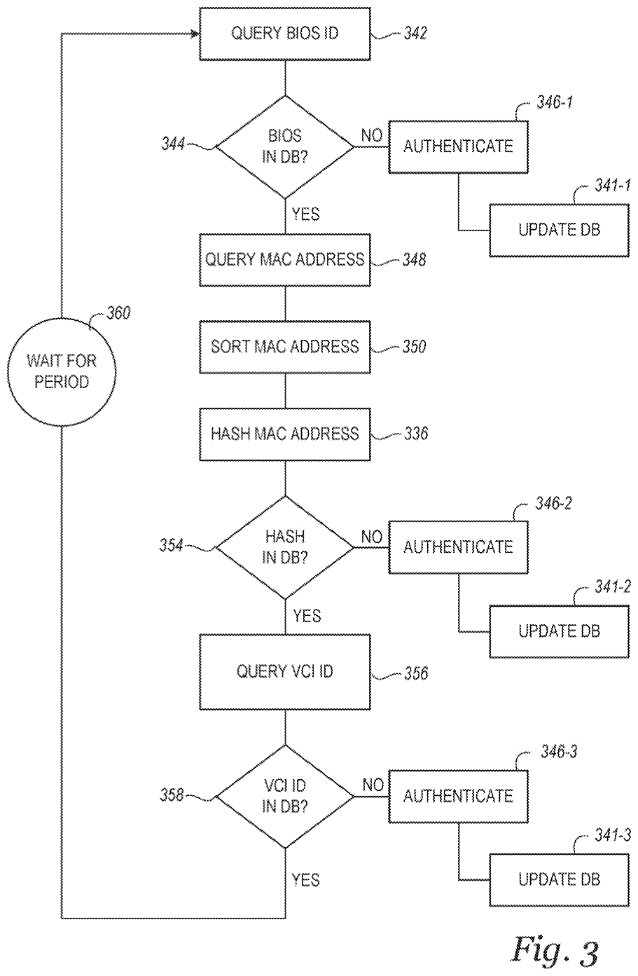

FIG. 3 is a flow chart for virtual computing instance agent authentication in a public cloud according to one or more embodiments of the present disclosure. The flow chart illustrated in FIG. 3 is a more detailed example of the periodic task described herein. After the periodic task begins, the agent can query a BIOS identifier of the VCI on which it is installed as indicated at 342. The agent can determine whether the BIOS identifier is stored in a database. If the BIOS identifier is not stored, then, in some embodiments an authentication process can begin as indicated at 346-1. The authentication process 346-1 can include authenticating the agent with the public cloud backend. In some embodiments, the authentication process 346-1 can include storing the BIOS identifier of the VCI in the database as indicated at 341-1. However, in some embodiments, more than one characteristic needs to be missing from the database before an authentication process 346 begins. If, at 344, the BIOS identifier is stored in the database, then the agent can query MAC addresses associated with the VCI on which it is installed as indicated at 348.

The agent can sort the MAC addresses as described herein and as indicated at 350. The agent can hash the sorted MAC addresses as indicated at 336. The agent can query the database to determine if the hash is stored therein as indicated at 354. If the hash is not stored in the database, an authentication process can begin as illustrated at 346-2. The authentication process 346-2 can essentially be the same as the authentication process 346-1 (or the authentication process 346-3). The agent can cause the characteristic (e.g., BIOS identifier, hash, VCI identifier) that is not found in the database to be stored therein as part of an update 341-2, which can be part of or separate from the authentication process 346-2. If, at 354, the hash is stored in the database, the agent can query the VCI identifier (if the public cloud backend supports VCI identifiers) as indicated at 356. In some embodiments, the periodic task can include querying the hash before the BIOS identifier. In other words, elements 348, 350, 336, and 354 can occur before elements 342 and 344.

The agent can determine whether the VCI identifier is in the database as indicated at 358. If the VCI identifier is not in the database, an authentication process can begin as illustrated at 346-3. The agent can cause the VCI identifier to be stored in the database as part of an update 341-3. If the VCI identifier is in the database, then the periodic task is complete, and the agent can wait for the next iteration of the periodic task as illustrated at 360. The next iteration of the periodic task can begin as illustrated at 342.

FIG. 4 is a flow chart for virtual computing instance agent authentication in a public cloud according to one or more embodiments of the present disclosure. The flow chart illustrated in FIG. 4 is a more detailed example of the authentication process described herein. The process illustrated in FIG. 4 can be launched, for example, at any of the authentication instances 346-1, 346-2, 346-3 illustrated in FIG. 3. When authentication is triggered, the agent can interrupt its own access to the public cloud backend as illustrated at 470. Prior to the access being interrupted, the agent can trigger an authentication process by communicating that to the public cloud backend. The details of how the public cloud backend authenticates the agent will be understood by one of ordinary skill in the art. The authentication of the agent is represented at 446. As part of or after the authentication process, the agent can register the BIOS identifier of the VCI on which it is installed, the hash of MAC addresses for the VCI on which it is installed, and/or the VCI identifier with the public cloud backend as illustrated at 474. In some embodiments, the agent can register each of those characteristics. In some embodiments, the agent can register only the specific characteristic that was missing from the database, and which triggered the authentication. Registering the characteristic can also be referred to as causing the characteristic to be stored in the database in association with the agent. Once the authentication and/or registration process is complete, the agent's access to the public cloud backend can be restored as illustrated at 476. The periodic task can resume at this point.

FIG. 5 is a flow chart for virtual computing instance agent authentication in a public cloud according to one or more embodiments of the present disclosure. The flow chart illustrated in FIG. 5 is a more detailed example of the change notification system described herein. An agent can create the change notification system on the VCI on which it is installed (e.g., when the agent is first initialized on the VCI). The guest operating system of the VCI can provide the change notification system, to which an agent can subscribe as illustrated at 580. If a MAC address associated with the VCI on which the agent is installed is updated (as illustrated at 582 by “change”), an internal flag can be set on the VCI as indicated at 584. The change notification system can run as part of the periodic task described herein. At 586, the periodic task can determine whether the flag is set. If the flag is not set, the periodic task can wait for a period as indicated at 560 on the “no” path from 586. If the flag (as indicated by the “yes” path from 586) and if authentication of the agent is not required as indicated by the “no” path from 588, the agent can be notified and the agent can add the updated MAC address to its sorted list as illustrated at 590. The agent can calculate a new or updated hash of the MAC addresses as illustrated at 536. In response to calculating the new hash, the agent can cause the database to be updated to store the new or updated hash as illustrated at 541. This step can prevent an already authenticated agent from reauthenticating due to a MAC address change. As part of updating the database or in response thereto, the flag can be reset as indicated at 592. However, if the agent needs to be authenticated as indicated by the “yes” path from 588, the authentication can proceed as described herein and as indicated at 546. The authentication can result in the database being updated as indicated at 541 and the flag being reset as indicated at 592.

The change notification can continue in this manner for the subscribed agent until it unsubscribes. If the agent is uninstalled from the VCI, as illustrated by the “yes” path from 594, it can be unsubscribed from the change notification system as illustrated at 598. If the agent remains installed (as indicated by the “no” path from 594), a determination can be made as to whether the VCI has been disabled at 596. If the VCI on which the agent is installed is disabled (as indicated by the “yes” path from 596), the agent can be unsubscribed from the change notification system as illustrated at 598. Otherwise, the change notification system can continue and the periodic task can wait for another period at 560.

As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is :

1. A method, comprising:
running a periodic task by an agent on a virtual computing instance (VCI) created from a VCI base image on a public cloud backend, wherein the VCI base image includes the agent;
wherein the periodic task comprises:
querying a basic input/output system (BIOS) identifier of the VCI;
calculating a hash of a string of media access control (MAC) addresses associated with the VCI; and
in response to the BIOS identifier or the hash not being stored in a database associated with the VCI, authenticating the agent with the public cloud backend.

2. The method of claim 1, further comprising causing the BIOS identifier and the hash to be stored in the database after authenticating the agent.

3. The method of claim 2, further comprising receiving, by the agent, an updated MAC address from a change notification system;
calculating a new hash of the string of MAC addresses associated with the VCI having the updated MAC address substituted therein; and
causing the new hash to be stored in the database without reauthenticating the agent.

4. The method of claim 1, wherein the periodic task further comprises:
querying a VCI identifier of the VCI; and
in response to the VCI identifier not being stored in the database, authenticating the agent with the public cloud backend.

5. The method of claim 1, wherein the periodic task further comprises:
querying the MAC addresses associated with the VCI; and
sorting the MAC addresses into the string.

6. The method of claim 1, further comprising:
creating the VCI base image;
installing the agent on the VCI base image;
storing a BIOS identifier of the VCI base image in a database associated with the VCI base image;
calculating a hash of a string of MAC addresses of the VCI base image;
storing the hash of the MAC addresses of the VCI base image in the database associated with the VCI base image; and
creating the periodic task to run on the VCI base image.

7. A system, comprising:
a public cloud backend configured to create a plurality of virtual computing instances (VCIs) from a VCI base image, each including a respective agent replicated from an agent installed on the VCI base image;
wherein the respective agent is configured to:
periodically determine whether a current basic input/output system (BIOS) identifier of the VCI on which the respective agent is installed matches a BIOS identifier stored in a database associated with the VCI;
periodically determine whether a current hash of MAC addresses matches a hash stored in the database; and
in response to not finding a match for either the current BIOS identifier or the current hash in the database, interrupt access to the public cloud backend for the respective agent until authenticated.

8. The system of claim 7, wherein the agent is configured to:
cause a BIOS identifier of the VCI base image to be stored in a database associated with the VCI base image; and
cause a hash of MAC addresses associated with the VCI base image to be stored in the database associated with the VCI base image.

9. The system of claim 7, wherein the respective agent is further configured to:
cause the current BIOS identifier of the VCI to be stored in the database in response to not finding a match for the current BIOS identifier in the database; and
cause the current hash of MAC addresses to be stored in the database in response to not finding a match for the current hash of MAC addresses in the database.

10. The system of claim 7, wherein the respective agent is further configured to authenticate with the public cloud backend in response to not finding a match for either the current BIOS identifier or the current hash in the database.

11. The system of claim 7, wherein the respective agent is further configured to periodically:
query the current BIOS identifier of the VCI;
query the MAC addresses associated with the VCI; and
calculate the current hash of MAC addresses.

12. The system of claim 11, wherein the respective agent is further configured to sort the MAC addresses in a same order each time the current hash is calculated.

13. The system of claim 11, wherein the respective agent is further configured, in response to being notified of a change of any MAC address associated with the VCI by a change notification system, to:
recalculate the current hash; and
cause the hash stored in the database to be updated.

14. The system of claim 13, wherein the respective agent is further configured to create the change notification system on the VCI.

15. The system of claim 7, wherein the respective agent is further configured to:
periodically query a VCI identifier of the VCI on which the respective agent is installed;
periodically determine whether the VCI identifier matches a corresponding VCI identifier stored in the database;
interrupt access to the public cloud backend for the respective agent until authenticated in response to not finding a match for the VCI identifier in the database.

16. The system of claim 7, wherein the public cloud backend is further configured to:
create the VCI base image; and
install the agent on the VCI base image, wherein the agent comprises proprietary software.

17. A non-transitory machine-readable medium having instructions stored thereon which, when executed by a processor, cause the processor to:
install an agent on a virtual computing instance (VCI) base image such that the agent is replicated to any VCI created from the VCI base image;
query a basic input/output system (BIOS) identifier of the VCI base image and store it in a database;
query MAC addresses associated with the VCI base image;
calculate a hash of the MAC addresses associated with the VCI base image;
store the hash in the database;
create a periodic task, comprising instructions to:
query a BIOS identifier of the VCI on which the agent is installed;
query MAC addresses associated with the VCI on which the agent is installed;
calculate a hash of the MAC addresses associated with the VCI on which the agent is installed; and
authenticate the agent with a public cloud backend on which the VCI and the VCI base image are running in response to either the BIOS identifier of the VCI on which the agent is installed or the hash of MAC addresses associated with the VCI on which the agent is installed not being found in the database.

18. The medium of claim 17, wherein the period task further comprises instructions to, in response to authentication of the agent:
store the BIOS identifier of the VCI on which the agent is installed in the database in response to the BIOS identifier of the VCI on which the agent is installed not being found in the database; and
store the hash of MAC addresses associated with the VCI on which the agent is installed in the database in response to the hash of MAC addresses associated with the VCI on which the agent is installed not being found in the database.

19. The medium of claim 17, further comprising instructions to notify the agent of any changes to the MAC addresses associated with the VCI on which the agent is installed;
recalculate the hash of the MAC addresses associated with the VCI on which the agent is installed in response to the notification; and
store the recalculated hash of the MAC addresses associated with the VCI on which the agent is installed without reauthenticating the agent.

20. The medium of claim 19, further comprising instructions to disable notifications to the agent in response to either of the agent being uninstalled from the VCI or the VCI being disabled.
